(19) United States
(12) Patent Application Publication
(10) Pub. No.: US 2015/0052488 A1
(43) Pub. Date: Feb. 19, 2015

(54) APPARATUS AND METHOD FOR PROVIDING AN ACTIVE SCREENSAVER

(71) Applicant: BLOOMBERG FINANCE L.P., New York, NY (US)

(72) Inventors: Iliya Rybchin, Scarsdale, NY (US); Oke Okaro, Montclair, NJ (US); Andrew Lack, Bronxville, NY (US); Stacy Kennedy, New York, NY (US); Chris Berend, Maplewood, NJ (US); Courtney Chapman, Brooklyn, NY (US); Gregg Fenton, Northport, NY (US)

(73) Assignee: BLOOMBERG FINANCE L.P., New York, NY (US)

(21) Appl. No.: 14/459,039

(22) Filed: Aug. 13, 2014

Related U.S. Application Data
(60) Provisional application No. 61/865,272, filed on Aug. 13, 2013.

(51) Int. Cl. G06F 3/01; G09G 1/16; G06F 3/0481

(52) U.S. Cl. CPC G06F 3/017; G06F 3/0481; G09G 1/16
USPC 715/867

(57) ABSTRACT

The present disclosure describes personalized active screensavers which are actionable and react to user preferences and user details. A presence of an individual is detected. The individual is analyzed to determine information related to the individual. Content is displayed on a display based on the determined information related to the individual. A screensaver mode is initiated on the display in response to the individual moving out of a predetermined range.

### BACKGROUND

Screensavers are typically passively displayed on digital devices. While they are capable of displaying customized information or data, they are not tailored specifically for interfacing with specific individuals in certain situations. It is thus desirable to have actionable screensavers that allow for personalization.

### SUMMARY

Embodiments of the present disclosure facilitate personalized active screensavers which are actionable and react to user preferences and user details.

In accordance with an embodiment of the present disclosure, a presence of an individual is detected. The individual is analyzed to determine information related to the individual. Content is displayed on a display based on the determined information related to the individual. A screensaver mode is initiated on the display in response to the individual moving out of a predetermined range.

In accordance with an embodiment, the individual is detected when the individual has entered a predetermined detection space or range.

In accordance with an embodiment, the individual is detected by either audio recognition or facial recognition.

In accordance with an embodiment, information obtained during the detection of the presence of the individual is matched to user profile information including user identification information and user preferences.

In accordance with an embodiment, content is displayed based on past content consumption of the individual.

In accordance with an embodiment, the content may be actionable by audio command, line of sight detection, or tactile tough.

In accordance with an embodiment, actionable content is displayed in screensaver mode based on the information related to the individual.

The embodiments described herein may furthermore be carried out on a computing device that performs operations based on execution of non-transitory computer readable medium having executable code stored thereon.

In accordance with an embodiment of the present disclosure, a non-transitory computer readable medium having executable code stored thereon, that when executed, causes a computing device to perform at least the following operations: detecting a presence of an individual; analyzing the individual to determine information related to the individual; displaying content on a display based on the determined information related to the individual; and initiating a screensaver mode on the display in response to the individual moving out of a predetermined range.

The embodiments described herein may furthermore be carried out on a system comprising at least an input unit, a control unit, and a display unit. The input unit may be configured for detecting a presence of an individual. The control unit may be configured for analyzing the individual to determine information related to the individual. The display unit may be configured for displaying content on a display based on the determined information related to the individual; and initiating a screensaver mode on the display in response to the individual moving out of a predetermined range.

The aforementioned embodiments and other advantages of the embodiments described herein will be apparent to those of ordinary skill in the art at least by reference to this summary, the following detailed description, and the accompanying drawings.

### BRIEF DESCRIPTION OF THE DRAWINGS

The systems and methods described herein may be better understood with reference to the following drawings and detailed description. Non-limiting and non-exhaustive embodiments are described with reference to the following drawings.

FIGS. 1A, 1B, and 1C illustrate exemplary diagrams of the embodiments of the present disclosure;

FIG. 2 illustrates an exemplary block diagram showing a device operating in accordance with the embodiments described herein;

FIG. 3 illustrates an exemplary flow diagram showing an algorithm in accordance with the embodiments described herein; and

FIG. 4 illustrates a high-level diagram of a computing device that may be used to implement various aspects of the present disclosure.

### DETAILED DESCRIPTION

Detailed embodiments of the present disclosure are provided herein. Any and all disclosed embodiments are merely exemplary and may be embodied in various and alternative forms, and combinations thereof. As used herein, “exemplary,” and similar terms, may refer expansively to embodiments that serve as an illustration, specimen, model, or pattern. The figures may include exaggerated or minimized features, in order to adequately show details of particular components. In certain instances, well-known components, systems, materials or methods that have not been described in detail in order to avoid obscuring from the focus of the present disclosure. Therefore, specific structural and functional details disclosed herein are in no way to be interpreted as limiting, but merely as a basis for the claims and as a representative basis recognizable to one skilled in the art to employ the present disclosure.

While the detailed description may include a general context of computer-executable instructions, the present disclosure may be implemented in combination with other program modules and/or as a combination of hardware and software. Thus, terms such as “computer” or “computing device” as used herein are expansive and are meant to include routines, program modules, programs, components, data structures, algorithms, and the like. Various systems may also be used for the implementation of the embodiments described herein, including single processor or multi-processor systems, minicomputers, mainframe computers, personal computers, hand-held computing devices, microprocessor-based computers, programmable consumer electronics, in-vehicle computing devices, and any of the aforementioned combinations thereof, and the like.

The present disclosure describes an apparatus and method for providing an active screensaver through a digital device based on information associated with users of the digital device. Digital device may mean a device connectable with a different device and capable of displaying screensavers, examples of which include, but are not limited to, computers, digital televisions, smart phones, camcorders, and other audio-visual devices.

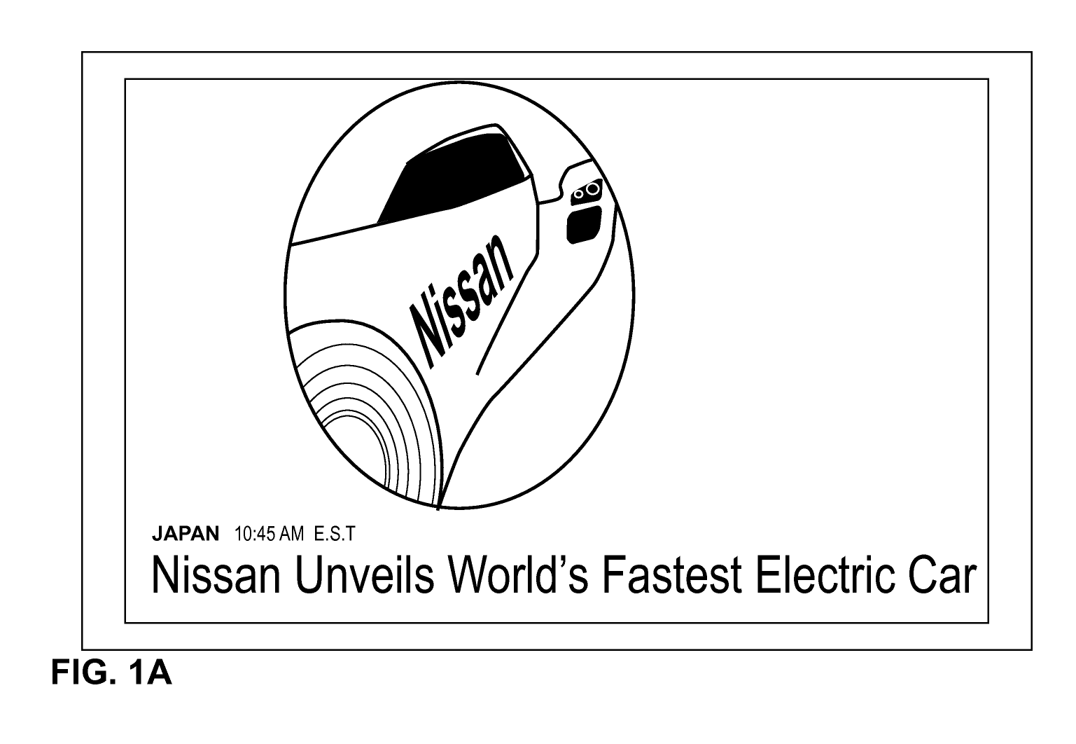

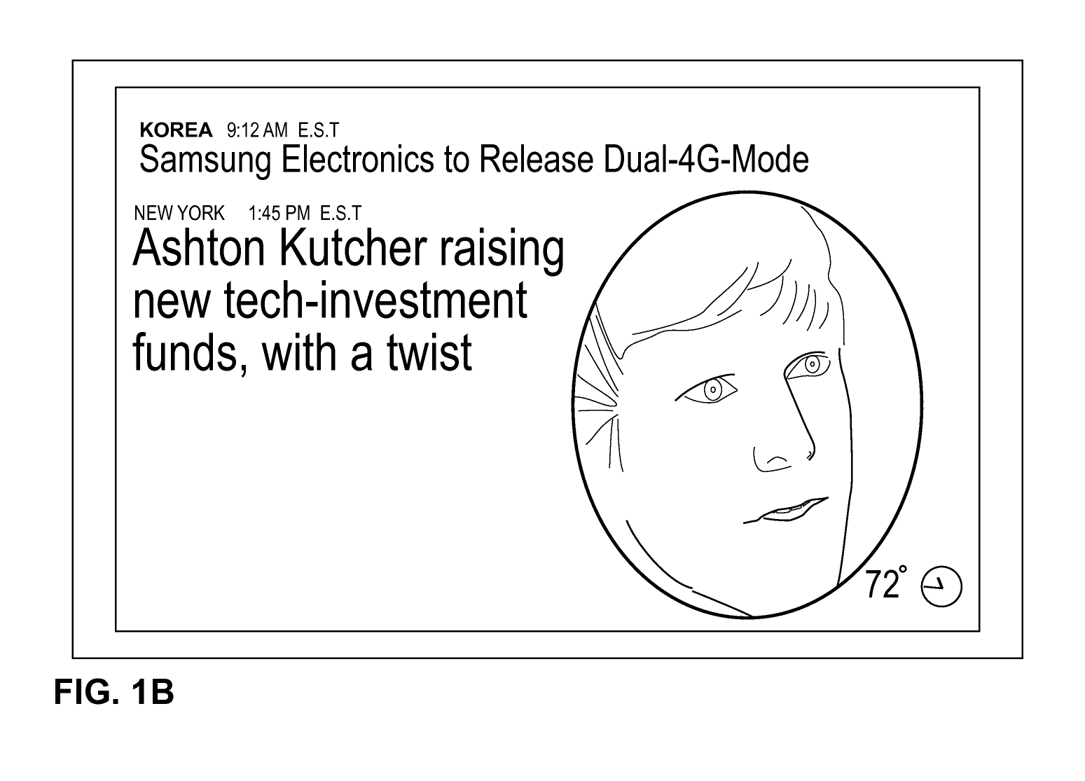

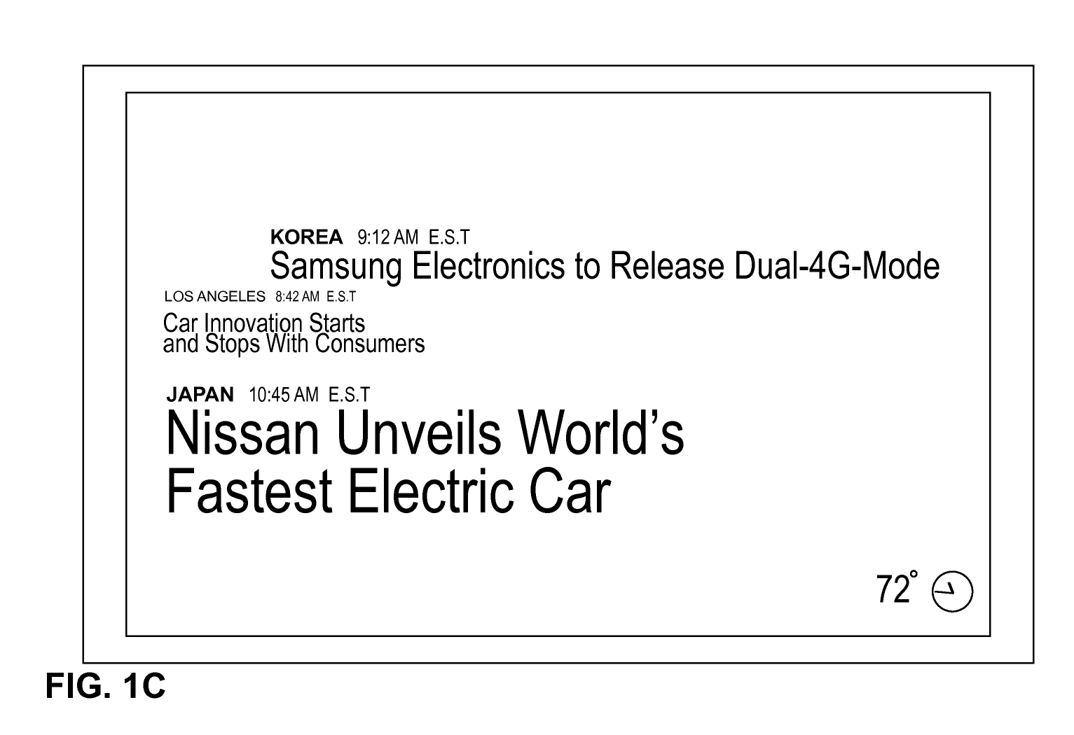

FIGS. 1A, 1B, and 1C illustrate exemplary diagrams of the embodiments of the present disclosure. FIGS. 1A, 1B, and 1C each illustrate an exemplary active screensaver displayed on a digital device. Each active screensaver displays exemplary content based upon detection of the presence of an individual who enters a designated area and analysis of information related to that individual. The content displayed is tailored to the individual based on user profile data associated with the individual.

FIG. 1A, for example, shows a headline describing the unveiling of a new electric car. This headline may be displayed based on user profile data indicating that a user is interested in electronic vehicles or fast cars. FIG. 1B, for example, shows a headline regarding new tech investment funds. This headline may be displayed based on user profile data indicating that a user is a venture capitalist or based on programming history showing that the user has viewed content related to technology investments. FIG. 1C, for example, provides a display of headlines describing both an electric car and a new mobile device technology.

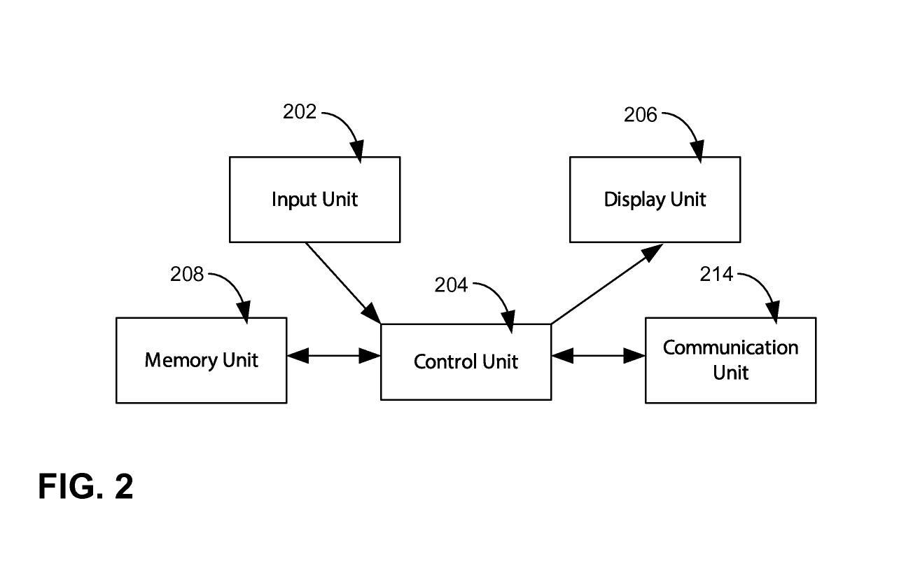

FIG. 2 illustrates an exemplary block diagram showing a device operating in accordance with the embodiments described herein. The digital device shown by FIG. 2 may include a control unit 204, a memory unit 208, an input unit 202, a display unit 206, and a communication unit 214.

Control unit 204 is responsible for overall control and operation of the digital device. Control unit 204 may, for example, be responsible for processing and controlling all data communications. Control unit 204 is responsible for initiating a screensaver for display on the digital device via display unit 206. Display unit 206 is capable of displaying numerals and characters, moving pictures, still pictures, and status information generated during any operation of the digital device. Display unit 206 may be a color liquid crystal display (LCD) or an active-matrix organic light-emitting diode (AMOLED). The initiation of a screensaver may occur, for example, when the digital device has been inactive or idle for a predetermined period of time.

Control unit 204 may also process data based on detection of the presence of an individual within a detection range of input unit 202. Input unit 202 may comprise at least a microphone for receiving audio data and a camera for recognizing and receiving facial recognition data. Input unit 202 may furthermore be configured to receive tactile or touch input. Input unit 202 is responsible for receiving and processing all external input provided by an individual within the detection range to control unit 204 for processing and analysis. When detecting the presence of an individual, input unit 202 first receives an indication that an individual is within detection range. Once an individual is in detection range, input unit 202 may receive input such as audio data of the individual's voice, or facial recognition data based on facial analysis of the individual. Any audio data and facial recognition data is thereafter provided by input unit 202 to control unit 204. When control unit 204 receives the audio data and facial recognition data, control unit 204 analyzes the audio data and facial recognition data.

Analysis of the audio data and facial recognition data may entail attempting to match either the audio data or the facial recognition data with user profile data stored in memory unit 208. Memory unit 208 may store user profiles associated with individuals, including data such as voice and facial features data for matching with the audio data or the facial recognition data. The user profiles may also store information relating to interests and viewing preferences related to a particular individual.

If there is a match between the received audio data or facial recognition data with any user profile data from memory unit 208, memory unit 208 will then provide any additional data relating to the individual to control unit 204. Control unit 204 may then use this additional data which includes information relating to interests and viewing preferences to cause display of content via display unit 206.

Communication unit 214 transmits/receives radio frequency (RF) signals inputted/outputted through an antenna (not shown). Communication unit 214 is also capable of receiving/transmitting data through wired communication. According to an exemplary embodiment of the present disclosure, communication unit 214 transmits instructions to external sources requesting programs or information based upon the information relating to interests and viewing preferences of an individual.

The above configurations of a digital device should be considered descriptively and should not be construed as limiting. Those skilled in the art will readily understand that various changes and modifications may be made to the configurations of the digital device without departing from the scope of the present disclosure. For example, although each of the input unit 202, display unit 206, memory unit 208, control unit 204, and communication unit 214 have been shown as separate units, any respective functions may be performed jointly or individually by any of the aforementioned units.

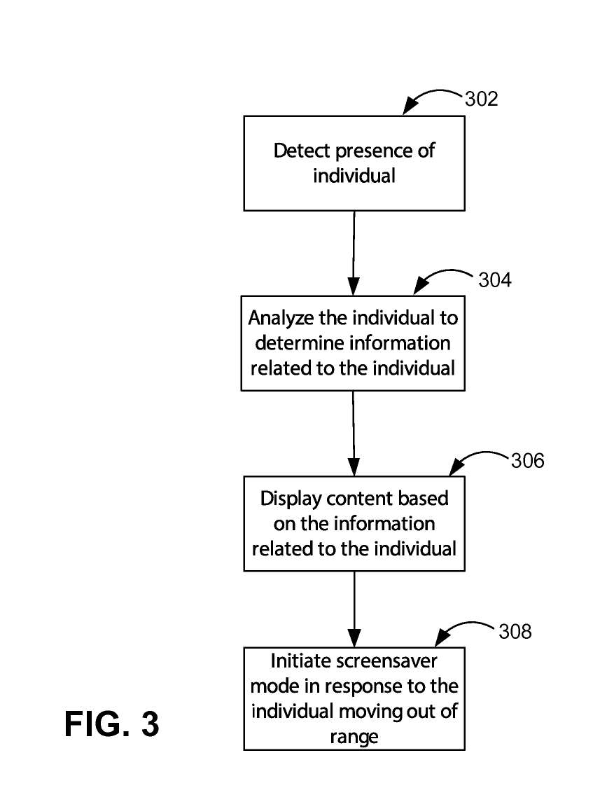

FIG. 3 illustrates an exemplary flow diagram showing an algorithm in accordance with the embodiments described herein. Method 300, as shown, illustrates an algorithm for displaying content within a screensaver based on detection of an individual. In an embodiment, a digital device, such as that described herein and in reference to FIG. 2, may detect the presence of an individual who enters a predetermined detection space. In a typical situation, the digital device may either be powered off or already in a passive screensaver mode prior to detecting the presence of an individual.

When the digital device is powered off, it may power on upon detection of the presence of an individual and thereafter enter an active screensaver mode. When the digital device is already in a passive screensaver mode, the detection of the presence of an individual may cause initiation of an active screensaver mode. A passive screensaver mode may be defined as a mode where the digital device displays a screensaver without additional content related to or associated with any individual watching or using the digital device. The passive screensaver mode may comprise displaying still images or moving images in a defined, predetermined fashion, without additional content. An active screensaver mode may be defined as a mode where additional content is displayed along with a traditional screensaver displayed in a passive screensaver mode. The additional content is tailored and customized based on the detected individual. In an active screensaver mode, the screensaver itself may also be changed to content customized for the detected individual. All display of screensavers or any content of the digital device is handled by display unit 206.

Detection of the presence of an individual, at step 302, within a predetermined detection space or range entails the usage of input unit 202, which may comprise a microphone for receiving audio data and a camera for receiving facial recognition data. In response to an individual speaking, the audio data is sent to the microphone of input unit 202. Alternatively, if the individual does not speak, the camera of input unit 202 will scan the face of the individual and receive facial recognition data for analysis.

The digital device will then utilize either the audio data or the facial recognition data, at step 304, to analyze the individual to determine information related to the individual. The analysis is performed by control unit 204. The analysis entails matching or cross referencing the audio data or the facial recognition data with user profile data stored in memory unit 208. Memory unit 208 stores user profile data including audio data and facial recognition data associated with particular individuals. This data may be stored based on registration of individuals, which entails creating a user profile containing audio data, facial recognition data, and information regarding interests, preferences, and content preferences associated with a particular individual. The user profile data may also be updated by the digital device based upon usage of the digital device by the individual. For example, if an individual watches sports more than 3 times per week, sports may be added to that individual's user profile as an interest. If the individual also watches news programs at exactly 5 PM each day, then this information may also be added to the user profile data as interests, preferences, and content preferences.

Once the individual has been identified using the audio data or facial recognition data, control unit 204 may thereafter retrieve the interests, preferences, and content preferences from the user profile data associated with that individual. Based on this, control unit 204 requests appropriate content from communication unit 214 for display by display unit 206. In accordance with an embodiment, it is also understood that certain content may be stored by memory unit 208 and thus may be retrieved from memory unit 208. Any content displayed with or on the active screensaver by display unit 206 is thus customized to the particular individual detected.

For example, when a first individual walks into a room or some other predetermined detection space or range, input unit 202 of the digital device will detect the individual via audio data or facial recognition data. After analysis of the audio data or facial recognition data in relation to user profile data to identify the individual, control unit 204 makes a determination of content to display via display unit 206. The screensaver may have been in a passive screensaver mode prior to detection of the individual or in an active screensaver mode presenting news, data, and other information. Upon detection of the individual and analysis to determine information related to the individual from the user profile data, the screensaver will adapt to display content tailored to that individual. For example, user profile data may indicate that a particular individual typically desires information regarding weather, traffic, and headline news in the morning prior to leaving work. Thus, for example, if the individual is detected at 8 AM in the morning, the screensaver will automatically adapt to display weather, traffic, and headline news for that user.

Thus, at step 306, content is displayed on the digital device based upon the information related to or associated with the individual. As mentioned, the content displayed is specifically tailored to preferences specified in user profile data related to the individual. Any content displayed may furthermore be actionable by the individual. For example, if the individual would like further information about weather, the individual can select an icon or portion on the display relating to the weather to obtain further information. The content may be actionable in several ways, including via audio command, visual line of sight detection, tactile touch, or traditional remote control selection. An instruction to activate actionable content is received by input unit 202.

The content that is displayed may also be dependent on the time of day, such that certain content may be daytime or nighttime exclusive. For example, certain content that may not be suitable during the daytime when children or minors may be around the digital device may be flagged as nighttime exclusive and will not appear until set times during the night.

At step 308, once the individual has moved outside of the detection range, the digital device may reinitiate a passive screensaver for display after a predetermined amount of time. For example, the individual steps away for more than five minutes, thus triggering initiation of a passive screensaver to be displayed by the digital device.

After the first individual leaves, if a second individual is detected later in the day, that individual is also analyzed based on their user profile data, such that personalized content will be presented to the second individual. For example, the second individual is detected and their user profile indicates a preference for fashion and celebrity news. Accordingly, the screensaver will display actionable content related to fashion and celebrity news personalized for the second individual.

In the event that an individual is not detected by the digital device, the digital device may prompt the individual to create a user profile. Alternatively, the digital device may simply ignore the individual and continue displaying in passive screensaver mode or stay powered off or in sleep mode.

It shall be understood that each block of a flowchart illustration need not be limited in the ordering shown in the illustration, and might be performed in any ordering, or even performed concurrently, without departing from the spirit of the embodiments described herein. It will also be understood that each block of the flowchart illustration, and combinations of blocks in the flowchart illustration, can be implemented by execution of computer program instructions. These program instructions might be provided to a processor to produce a machine, such that the instructions, which execute on the processor, create means for implementing the actions specified in the flowchart block or blocks. The computer program instructions might be executed by a processor to cause a series of operational steps to be performed by the processor to produce a computer implemented process such that the instructions, which execute on the processor to provide steps for implementing the actions specified in the flowchart block or blocks.

Accordingly, blocks of the flowchart illustration support combinations of means for performing the specified actions, combinations of steps for performing the specified actions and program instruction means for performing the specified actions. It will also be understood that each block of the flowchart illustration, and combinations of blocks in the flowchart illustration, can be implemented by special purpose hardware-based systems which perform the specified actions or steps, or combinations of special purpose hardware and computer instructions.

All systems and methods described herein may be implemented using digital circuitry, or using one or more computers using well-known computer processors, memory units, storage devices, computer software, and other components. Typically, a computer includes a processor for executing instructions and one or more memories for storing instructions and data. A computer may also include, or be coupled to, one or more mass storage devices, such as one or more magnetic disks, internal hard disks and removable disks, magneto-optical disks, optical disks, etc.

All systems and methods described herein may also be implemented using computers operating in a client-server relationship. Typically, in such a system, the client computer is located remotely from the server computer and interaction takes place via a network. The client-server relationship may be defined and controlled by computer programs executing on their respective client and server computers.

All systems and methods described herein may be implemented using a computer program product tangibly embodied in an information carrier, e.g., in a non-transitory machine-readable storage, for execution by a programmable processor; and the method steps described herein may be implemented using one or more computer programs executable by such processor. A computer program may be a set of computer program instructions that can be used, directly or indirectly, by a computer to perform a certain activity or bring about a certain result. A computer program may be written in any form of programming language, including compiled or interpreted languages, and may be deployed in any form, including as a stand-alone program or as a module, component, subroutine, or other unit suitable for use in a computing environment.

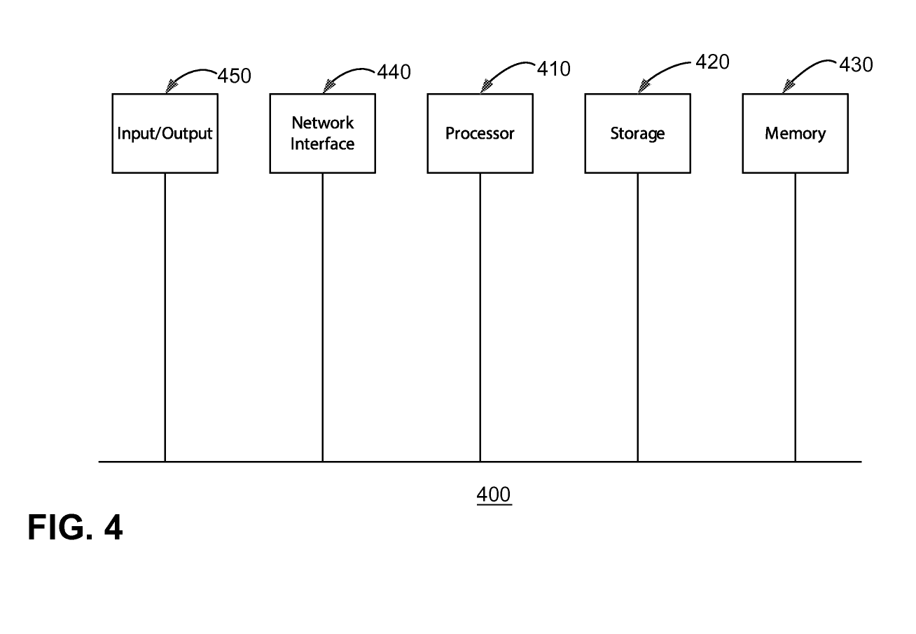

FIG. 4 illustrates a high-level diagram of a computing device that may be used to implement various aspects of the present disclosure. Computing device 400 comprises a processor 410 operatively coupled to a data storage device 420 and a memory 430. Processor 410 controls the overall operation of computing device 400 by executing computer program instructions that define such operations. The computer program instructions may be stored in data storage device 420, or other computer readable mediums, and loaded into memory 430 when execution of the computer program instructions is desired. Thus, at least the method steps of FIG. 3 can be defined by the computer program instructions stored in memory 430 and/or data storage 420 and controlled by processor 410 executing the computer program instructions. For example, the computer program instructions can be implemented as computer executable code programmed by one skilled in the art to perform at least the algorithms defined by the method steps of FIG. 3. Computing device 400 also includes one or more network interfaces for communicating with other devices via a network. Computing device 400 also includes one or more input/output devices 450 that enable user interaction with computing device 400 (e.g., display, keyboard, mouse, speakers, buttons, etc.).

Processor 410 may include both general and special purpose microprocessors, and may be the sole processor or one of multiple processors of computing device 400. Processor 410 may comprise one or more central processing units (CPUs), for example. Processor 410, data storage device 420, and/or memory 430 may include, be supplemented by, or incorporated in, one or more application-specific integrated circuits (ASICs) and/or one or more field programmable gate arrays (FPGAs).

Data storage 420 and memory 430 each comprise a tangible non-transitory computer readable storage medium. Data storage 420, and memory 430, may each include high-speed random access memory, such as dynamic random access memory (DRAM), static random access memory (SRAM), double data rate synchronous dynamic random access memory (DDR RAM), or other random access solid state memory devices, and may include non-volatile memory, such as one or more magnetic disk storage devices such as internal hard disks and removable disks, magneto-optical disk storage devices, optical disk storage devices, flash memory devices, semiconductor memory devices, such as erasable programmable read-only memory (EPROM), electrically erasable programmable read-only memory (EEPROM), compact disc read-only memory (CD-ROM), digital versatile disc read-only memory (DVD-ROM) disks, or other non-volatile solid state storage devices.

Input/output devices 450 may include peripherals, such as a printer, scanner, display screen, etc. For example, input/output devices 450 may include a display device such as a cathode ray tube (CRT) or liquid crystal display (LCD) monitor for displaying information to the user, a keyboard, and a pointing device such as a mouse or a trackball by which the user can provide input to computing device 400.

One skilled in the art will readily recognize that any implementation of an actual computer, computer system, or computing device may have other structures and may contain other components, and that computing device 400 is merely a high level representation of some of the components for illustrative purposes.

The foregoing detailed description of the present disclosure is to be understood as being in every respect illustrative and exemplary, but not restrictive, and the scope of the present disclosure provided herein is not to be determined solely from the detailed description, but rather from the claims as interpreted according to the full breadth and scope permitted by patent laws. It is to be understood that the embodiments shown and described herein are merely illustrative of the principles addressed by the present disclosure and that various modifications may be implemented by those skilled in the art without departing from the scope and spirit of the present disclosure. Those skilled in the art may implement various other feature combinations without departing from the scope and spirit of the present disclosure. The various functional modules shown are for illustrative purposes only, and may be combined, rearranged and/or otherwise modified.

We claim:

1. A non-transitory computer readable medium having executable code stored thereon, that when executed, causes a computing device to perform operations comprising:
detecting a presence of an individual;
analyzing the individual to determine information related to the individual;
displaying content on a display based on the determined information related to the individual; and
initiating a screensaver mode on the display in response to the individual moving out of a predetermined range.

2. The non-transitory computer readable medium of claim 1, wherein the operation of detecting a presence of an individual comprises:
detecting that the individual has entered a predetermined detection space.

3. The non-transitory computer readable medium of claim 1, wherein the operation of detecting a presence of an individual comprises:
detecting the individual by at least one of audio recognition or facial recognition.

4. The non-transitory computer readable medium of claim 1, wherein the operation of analyzing the individual to determine information related to the individual comprises:
matching information obtained during detecting the presence of the individual to user profile information including user identification information and user preferences.

5. The non-transitory computer readable medium of claim 1, wherein the operation of displaying content on a display based on the determined information related to the individual comprises:
displaying content based on past content consumption of the individual.

6. The non-transitory computer readable medium of claim 1, wherein the operation of displaying content on a display based on the determined information related to the individual comprises:
displaying content based on a time of the day.

7. The non-transitory computer readable medium of claim 1, wherein the content is actionable.

8. The non-transitory computer readable medium of claim 7, wherein the content is actionable by at least one of audio command, line of sight detection, or tactile touch.

9. The non-transitory computer readable medium of claim 1, wherein the operation of initiating a screensaver mode on the display in response to the individual moving out of a predetermined range comprises:
displaying actionable content in screensaver mode based on the information related to the individual.

10. A method for allocating order flow for providing an active screensaver, comprising:
detecting a presence of an individual;
analyzing the individual to determine information related to the individual;
displaying content on a display based on the determined information related to the individual; and
initiating a screensaver mode on the display in response to the individual moving out of a predetermined range.

11. The method of claim 10, wherein detecting a presence of an individual comprises:
detecting that the individual has entered a predetermined detection space.

12. The method of claim 10, wherein detecting a presence of an individual comprises:
detecting the individual by at least one of audio recognition or facial recognition.

13. The method of claim 10, wherein analyzing the individual to determine information related to the individual comprises:
matching information obtained during detecting the presence of the individual to user profile information including user identification information and user preferences.

14. The method of claim 10, wherein displaying content on a display based on the determined information related to the individual comprises:
displaying content based on past content consumption of the individual.

15. The method of claim 10, wherein displaying content on a display based on the determined information related to the individual comprises:
displaying content based on a time of the day.

16. The method of claim 10, wherein the content is actionable.

17. The method of claim 16, wherein the content is actionable by at least one of audio command, line of sight detection, or tactile touch.

18. The method of claim 10, wherein initiating a screensaver mode on the display in response to the individual moving out of a predetermined range comprises:
displaying actionable content in screensaver mode based on the information related to the individual.

19. A system comprising:
an input unit configured for detecting a presence of an individual;
a control unit configured for analyzing the individual to determine information related to the individual; and
a display unit configured for:
displaying content on a display based on the determined information related to the individual; and
initiating a screensaver mode on the display in response to the individual moving out of a predetermined range.

20. The system of claim 19, wherein the input unit is further configured for:
detecting that the individual has entered a predetermined detection space.

21. The system of claim 19, wherein the input unit is further configured for:
detecting the individual by at least one of audio recognition or facial recognition.

22. The system of claim 19, wherein the control unit is further configured for:
matching information obtained during detecting the presence of the individual to user profile information including user identification information and user preferences.

23. The system of claim 19, wherein the display unit is further configured for:
displaying content based on past content consumption of the individual.

24. The system of claim 19, wherein the display unit is further configured for:
displaying content based on a time of the day.

25. The system of claim 19, wherein the content is actionable.

26. The system of claim 25, wherein the content is actionable by at least one of audio command, line of sight detection, or tactile touch.

27. The system of claim 19, wherein the display unit is further configured for:
displaying actionable content in screensaver mode based on the information related to the individual.
